(19) United States
(12) Patent Application Publication
(10) Pub. No.: US 2007/0066703 A1
(43) Pub. Date: Mar. 22, 2007

(54) Radiation-curable resin composition, cured film of the composition, and laminate

(76) Inventors: Noriyasu Shinohara, Tokyo (JP); Hiroyuki Mano, Tokyo (JP); Takayoshi Tanabe, Tsukuba (JP); John Edmond Southwell, Elgin, IL (US); Christopher Frederic Tronche, Schaumburg, IL (US)

Correspondence Address: NIXON & VANDERHYE, PC, 901 NORTH GLEBE ROAD, 11TH FLOOR, ARLINGTON, VA, 22203, US

(21) Appl. No.: 10/564,816

(22) PCT Filed: Jul. 23, 2004
(86) PCT No.: PCT/NL04/00533

§ 371 Date: Jun. 13, 2006

(30) Foreign Application Priority Data
Jul. 23, 2003 (JP) JP2003-278211

(51) Int. Cl. C03C 25/10

(52) U.S. Cl. 522/172

(57) ABSTRACT

The present invention relates to a radiation-curable resin composition which produces a cured film having low surface resistivity and high transparency, a cured film of the composition, and a laminate including a layer of the cured film. The laminate of the present invention is suitably used as a hard coat material for preventing scratches or stains on a plastic optical part, touch panel, film-type liquid crystal element, plastic container, or flooring material, wall material, or artificial marble as an architectural interior finish; adhesive and sealing material for various substrates; vehicle for printing ink; or the like.

### TECHNICAL FIELD

The present invention relates to a radiation-curable resin composition which produces a cured film having low surface resistivity and high transparency, a cured film of the composition, and a laminate including a layer of the cured film. The laminate of the present invention is suitably used as a hard coat material for preventing scratches or stains on a plastic optical part, touch panel, film-type liquid crystal element, plastic container, or flooring material, wall material, or artificial marble as an architectural interior finish; adhesive and sealing material for various substrates; vehicle for printing ink; or the like.

### BACKGROUND ART

In order to ensure performance of information communication instruments and to provide safety measures, a film having scratch resistance and adhesion (hard coat) or a film having an antistatic function (antistatic film) has been formed on the surface of the information communication instrument using a radiation-curable composition.

In recent years, information communication instruments have developed remarkably and been widely used. Therefore, further improvement of the performance and productivity of the antistatic film and the like has been demanded.

In particular, prevention of adhesion of dust due to static electricity has been demanded for an optical article such as a plastic lens. Prevention of adhesion of dust due to static electricity has been demanded for a display panel.

To deal with these demands, various radiation curable materials have been proposed due to high productivity and curability at room temperature.

For example, a composition including a chain-like metal powder (Japanese Patent Application Laid-open No. 55-78070), a composition including tin oxide particles, a polyfunctional acrylate, and a copolymer of methylmethacrylate and polyether acrylate as essential components (Japanese Patent Application Laid-open No. 60-60166), a conductive paint composition including a pigment coated with a conductive polymer (Japanese Patent Application Laid-open No. 2-194071), and an optical disk material including a trifunctional acrylate, a compound containing a monofunctional ethylenically unsaturated group, a photoinitiator, and a conductive powder (Japanese Patent Application Laid-open No. 4-172634) have been disclosed. A conductive paint including a hydrolyzate of antimony-doped tin oxide particles and tetraalkoxysilane dispersed using a silane coupler, a photosensitizer, and an organic solvent (Japanese Patent Application Laid-open No. 6-264009) has also been disclosed. Furthermore, a curable liquid resin composition including a reaction product of alkoxysilane containing a polymerizable unsaturated group in the molecule with metal oxide particles, a trifunctional acrylic compound, and a radiation polymerization initiator (Japanese Patent Application Laid-open No. 2000-143924) has been disclosed.

These conventional technologies are effective to a certain extent. However, the conventional technologies are not necessarily satisfactory as a cured film which is required to exhibit all the functions of a hard coat or antistatic film.

Specifically, the conventional technologies have problems in that transparency is decreased by dispersing the chain-like metal powder with a large particle size, the strength of the cured film is decreased due to the presence of a large amount of incurable dispersant, transparency is decreased by blending a high-concentration of electrostatic inorganic particles, and a manufacturing method of the composition exhibiting antistaticity is not disclosed. Therefore, the conventional technologies do not solve all of these problems.

A person skilled in the art would easily have come up with the idea of combining conductive particles at a high concentration in order to improve antistatic performance. In this case, it is difficult to prevent a decrease in dispersibility. As a result, transparency is decreased due to an increased haze value of the cured film, and curability is decreased due to a decrease in UV transmittance. Moreover, adhesion to a substrate and leveling properties of the applied liquid are impaired.

However, a composition which satisfies these requirements has not been obtained.

### DISCLOSURE OF THE INVENTION

### Problem to be Solved by the Invention

The present invention has been achieved in view of the above-described problems. An object of the present invention is to provide a radiation-curable resin composition which produces a cured film which has a low surface resistivity and high transparency and is useful as a hard coat, a cured film of the composition, and a laminate which has low surface resistivity and high transparency and is useful as a antistatic hard coat.

### MEANS FOR SOLVING THE PROBLEM

The present inventors have conducted extensive studies in view of the above-described situation. As a result, the present inventors have found that a laminate which has low surface resistivity and high transparency and is useful as a antistatic hard coat can be obtained by disposing a layer obtained by curing a radiation-curable resin composition comprising reactive particles, a radically polymerizable compound, a salt of an inorganic acid and/or an organic acid, and optionally an organic polymer including a structural unit derived from an alkylene glycol by applying radiation in contact with another layer exhibiting conductivity. This finding has led to the completion of the present invention.

Specifically, the present invention provides a radiation-curable resin composition comprising oxide particles including a polymerizable unsaturated group on a surface layer, a radically polymerizable compound including two or more functional groups, a salt of an inorganic acid and/or an organic acid, and an organic polymer including a structural unit derived from an alkylene glycol, a cured film obtained by curing the radiation-curable resin composition by applying radiation, and a laminate comprising a substrate layer and a layer of the cured film, and preferably a first layer exhibiting conductive between the substrate layer and a second layer of the cured film.

### EFFECT OF THE INVENTION

The radiation-curable resin composition of the present invention produces a cured film having low surface resistivity and high transparency. The cured film having such characteristics is obtained by curing the composition of the present invention by applying radiation. The cured film is useful as a hard coat.

The laminate of the present invention is useful as an antistatic hard coat having low surface resistivity and high transparency. The laminate is suitably used as a hard coat material for preventing scratches or stains on a plastic optical part, touch panel, film-type liquid crystal element, plastic container, or flooring material, wall material, or artificial marble as an architectural interior finish; adhesive and sealing material for various substrates; vehicle for printing ink; or the like.

### BEST MODE FOR CARRYING OUT THE INVENTION

The components of the radiation-curable resin composition of the present invention are described below.

(A) Oxide Particles Including Polymerizable Unsaturated Group on Surface Layer

Oxide particles including polymerizable unsaturated groups on their surface layer are known, and may be produced by any known method.

A method to provide oxide particles (A) including a polymerizable unsaturated groups on the surface layer (hereinafter called “reactive oxide particles (A)”) used in the radiation curable resin composition (Aa) with an organic compound including a polymerizable unsaturated group and a structure of the following formula (1) (hereinafter called “organic compound (Ab)”). 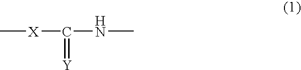
wherein X represents NH, O (oxygen atom), or S (sulfur atom), and Y represents O or S.
(1) Oxide Particles (Aa)

The oxide particles (Aa) are preferably in the form of powder or solvent dispersion sol. In the case where the oxide particles (Aa) are solvent dispersion sol, an organic solvent is preferably used as the dispersion medium from the viewpoint of miscibility and dispersibility with other components. As examples of organic solvents, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. Of these, methanol, ethanol, isopropanol, N-butanol, methyl ethyl ketone, methyl isobutyl ketone, ethyl acetate, butyl acetate, toluene, and xylene are preferable. The most preferred solvents are methanol, ethanol, isopropanol and N-butanol. It is believed that trace amounts of the H₂O which are always present in alcohols play a role in achieving the desired low surface resistivity. Thus, solvents inherently comprising some H₂O are preferred.

The number average particle diameter of the oxide particles (Aa) is preferably from 0.001 to 2 μm, still more preferably from 0.001 to 0.2 μm, and particularly preferably from 0.001 to 0.1 μm. If the number average particle diameter exceeds 2 μm, transparency of the resulting cured film may be decreased or surface conditions of the resulting film may be impaired. Various surfactants and amines may be added in order to improve dispersibility of the particles.

In a preferred embodiment, silica particles are used as the oxide particles (Aa). As examples of commercially available products of silica particles, colloidal silica such as Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like can be given.

As examples of commercially available products of powdered silica, AEROSIL 130, AEROSIL 300, AEROSIL 380, AEROSIL TT600, and AEROSIL OX50 (manufactured by Nippon Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), SYLYSIA 470 (manufactured by Fuji Silysia Chemical, Ltd.), SG Flake (manufactured by Nippon Sheet Glass Co., Ltd.), and the like can be given.

The shape of the oxide particles (Aa) may be globular, hollow, porous, rod-like, plate-like, fibrous, or amorphous. Of these, a globular shape is preferable.

The specific surface area of the oxide particles (Aa) (determined by a BET method using nitrogen) is preferably 10 to 1000 m²/g, and still more preferably 100 to 500 m²/g.

The oxide particles (Aa) may be used either in the form of dry powder or by dispersion in water or an organic solvent. For example, an organic solvent dispersion liquid of fine oxide particles commercially available as solvent dispersion sol of the above oxide may be directly used. In particular, use of a solvent dispersion sol of oxide is preferable in applications in which high transparency is necessary for the cured film. In the composition according to the invention, a mixture of conductive and non-conductive oxide particles may be present. Preferably, more non-conductive oxide particles are present than conductive oxide particles. Preferably only non-conductive oxide particles are present. All oxide particles which are not doped but are essentially consisting of the oxide of one element are defined as non-conductive oxide particles.

(2) Organic Compound (Ab)

The organic compound (Ab) is e.g. a compound that includes a polymerizable unsaturated group and the structure of the following formula (1) as described above. 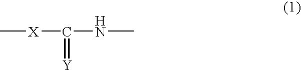
wherein X represents NH, O (oxygen atom), or S (sulfur atom), and Y represents O or S.

The organic compound (Ab) is preferably either a compound including a silanol group or a compound which forms a silanol group by hydrolysis.

Polymerizable Unsaturated Group

There are no specific limitations to the polymerizable unsaturated group included in the organic compound (Ab). An acryloyl group, methacryloyl group, vinyl group, propenyl group, butadienyl group, styryl group, ethynyl group, cinnamoyl group, maleate group, and acrylamide group can be given as suitable examples.

The polymerizable unsaturated group is a structural unit which undergoes addition polymerization by active radical species.

Structure of Formula (1)

The structure of the above formula (1) included in the organic compound (Ab) includes [—O—C(═O)—NH—], [—O—C(═S)—NH—], [—S—C(═O)—NH—], [—NH—C(═O)—NH—], [—NH—C(═S)—NH—], and [—S—C(═S)—NH—]. The organic compound (Ab) may include these structures either individually or in combination of two or more. The organic compound (Ab) preferably includes the group [—O—C(═O)—NH—] and at least either the group [—O—C(═S)—NH—] or the group [—S—C(═O)—NH—] from the viewpoint of thermal stability.

If the organic compound (Ab) includes the structure of the above formula (1), characteristics such as excellent mechanical strength, adhesion to a substrate, and heat resistance are provided to the cured film of the radiation-curable resin composition of the present invention.

Compound Including Silanol Group or Compound which Forms Silanol Group by Hydrolysis

The organic compound (Ab) is preferably either a compound including a silanol group (hereinafter may be called “silanol group-containing compound”) or a compound which forms a silanol group by hydrolysis (hereinafter may be called “silanol group-forming compound”). As the silanol group-forming compound, a compound in which an alkoxy group, aryloxy group, acetoxy group, amino group, a halogen atom, or the like is bonded to a silicon atom can be given. Of these, a compound in which an alkoxy group or an aryloxy group is bonded to a silicon atom, specifically, a compound containing an alkoxysilyl group or a compound containing an aryloxysilyl group is preferable.

The silanol group or the silanol group-forming site of the silanol group-forming compound is a structural unit which is bonded to the silica particles (Aa) by condensation or condensation occurring after hydrolysis.

Preferable Organic Compound (Ab)

Compounds of the following formula (2) can be given as preferable specific examples of the organic compound (Ab). 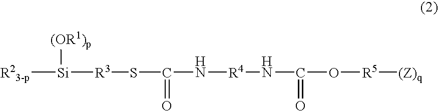
wherein R¹ and R² individually represent a hydrogen atom, an alkyl group or aryl group having 1-8 carbon atoms, such as a methyl group, ethyl group, propyl group, butyl group, octyl group, phenyl group, or xylyl group, and p is an integer from 1 to 3.

As examples of the group [(R¹⁰)ₚR²₃₋ₚSi—], a trimethoxysilyl group, triethoxysilyl group, triphenoxysilyl group, methyldimethoxysilyl group, dimethylmethoxysilyl group, and the like can be given. Of these, a trimethoxysilyl group or a triethoxysilyl group is preferable.

R³ is a divalent organic group having a C₁-C₁₂ aliphatic or aromatic structure, and may include a linear, branched, or cyclic structure.

R⁴ is a divalent organic group and is generally selected from divalent organic groups having a molecular weight of 14 to 10,000, and preferably 76 to 500.

R⁵ is an organic group with a valence of (q+1) and is preferably selected from linear, branched, and cyclic saturated and unsaturated hydrocarbon groups.

Z is a monovalent organic group including a polymerizable unsaturated group in the molecule which undergoes an intermolecular crosslinking reaction in the presence of active radicals. q is preferably an integer from 1 to 20, more preferably from 1 to 10, and particularly preferably from 1 to 5.

The organic compound (Ab) used in the present invention may be synthesized by using a method described in Japanese Patent Application Laid-open No. 9-100111, for example.

The amount of the organic compound (Ab) on the surface layer of the oxide particles (Aa) is preferably 0.01 wt % or more, still more preferably 0.1 wt % or more, and particularly preferably 1 wt % or more of 100 wt % of the oxide particles (Aa) and the organic compound (Ab) in total. If the amount is less than 0.1 wt %, dispersibility of the reactive oxide particles (A) in the composition may be impaired, whereby transparency and scratch resistance of the resulting cured film may be insufficient.

The amount of the oxide particles (Aa) in the raw materials when preparing the reactive silica particles (A) is preferably 5 to 99 wt %, and still more preferably 10 to 98 wt %.

The amount (content) of the component (A) used in the present invention is preferably 5 to 90 wt %, and still more preferably 10 to 80 wt % of 100 wt % of the components (A), (B), (C), and (D) in total. If the amount (content) of the component (A) is less than 5 wt %, the resulting cured film may exhibit insufficient hardness. If the amount (content) of the component (A) exceeds 90 wt %, film formability may become insufficient.

(B) Radically Polymerizable Compound Including Two or More Functional Groups

The radically polymerizable compound (B) used in the radiation-curable resin composition of the present invention is a compound including two or more polymerizable unsaturated groups. Typical examples include compounds including two to six polymerizable unsaturated groups. The component (B) is suitably used to increase film-formability of the composition.

There are no specific limitations to the component (B) insofar as the component (B) includes two or more polymerizable unsaturated groups in the molecule. As examples of the component (B), melamine acrylates, (meth))acrylates, vinyl compounds, and the like can be given. Of these, (meth))acrylates are preferable. In order to increase film-formability, the component (B) preferably includes three or more functional groups, still more preferably four or more functional groups, and particularly preferably six functional groups.

Specific examples of the component (B) used in the present invention are given below.

As examples of (meth))acrylates, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, poly(meth)acrylates of ethylene oxide or propylene oxide addition product of starting alcohols of these (meth))acrylates, oligoester(meth)acrylate, oligoether(meth)acrylate, oligourethane(meth)acrylate, and oligoepoxy(meth)acrylate including two or more (meth)acryloyl groups in the molecule, and the like can be given. Of these, dipentaerythritol hexa(meth)acrylate, dipentaerythritol penta(meth)acrylate, pentaerythritol tetra(meth)acrylate, and ditrimethylolpropane tetra(meth)acrylate are preferable.

As vinyl compounds, divinylbenzene, ethylene glycol divinyl ether, diethylene glycol divinyl ether, triethylene glycol divinyl ether, and the like can be given.

As examples of commercially available products of the component (B), Nikalac MX-302 (manufactured by Sanwa Chemical Co., Ltd.), Aronix M-400, M-408, M-450, M-305, M-309, M-310, M-315, M-320, M-350, M-360, M-208, M-210, M-215, M-220, M-225, M-233, M-240, M-245, M-260, M-270, M-1100, M-1200, M-1210, M-1310, M-1600, M-221, M-203, TO-924, TO-1270, TO-1231, TO-595, TO-756, TO-1343, TO-902, TO-904, TO-905, TO-1330 (manufactured by Toagosei Co., Ltd.); KAYARAD D-310, D-330, DPHA, DPCA-20, DPCA-30, DPCA-60, DPCA-120, DN-0075, DN-2475, SR-295, SR-355, SR-399E, SR-494, SR-9041, SR-368, SR-415, SR-444, SR-454, SR-492, SR-499, SR-502, SR-9020, SR-9035, SR-111, SR-212, SR-213, SR-230, SR-259, SR-268, SR-272, SR-344, SR-349, SR-601, SR-602, SR-610, SR-9003, PET-30, T-1420, GPO-303, TC-120S, HDDA, NPGDA, TPGDA, PEG400DA, MANDA, HX-220, HX-620, R-551, R-712, R-167, R-526, R-551, R-712, R-604, R-684, TMPTA, THE-330, TPA-320, TPA-330, KS-HDDA, KS-TPGDA, KS-TMPTA (manufactured by Nippon Kayaku Co., Ltd.); Light-Acrylate PE-4A, DPE-6A, DTMP-4A (manufactured by Kyoeisha Chemical Co., Ltd.); and the like can be given.

The amount (content) of the component (B) used in the present invention is preferably 5 to 80 wt %, and still more preferably 10 to 50 wt % of 100 wt % of the components (A), (B), (C), and (D) in total. If the amount is less than 5 wt % or exceeds 80 wt %, the resulting cured film may exhibit insufficient hardness.

In addition to the compound (B), a compound including one polymerizable unsaturated group in the molecule may be used in the composition of the present invention, if necessary.

(C) Salt of Inorganic Acid and/or Organic Acid

The salt of an inorganic and/or organic acid may be a salt which produces ions in the presence of (D) an organic polymer including a structural unit derived from an alkylene glycol and transports electric charges is necessary for the radiation-curable resin composition of the present invention. As a salt which produces ions in the presence of (D), an organic polymer including a structural unit derived from an alkylene glycol and transports electric charges, a salt consisting of at least the following cation and anion can be given.

As examples of cations of the salt used in the present invention, alkaline metal ions such as a lithium ion, sodium ion, and potassium ion, alkaline earth metal ions such as a beryllium ion, magnesium ion, and calcium ion, tetraalkylammonium ions such as a tetramethylammonium ion, tetraethylammonium ion, and tetra-n-butylammonium ion, aromatic quaternary ammonium ions such as a trimethylbenzylammonium ion, triethylbenzylammonium ion, and tributylbenzylammonium ion, heterocyclic quaternary ammonium ion such as an alkylpyridinium ion, and the like can be given. Of these, a lithium ion, sodium ion, and tetraalkylammonium ion are preferable.

As examples of anions of the salt used in the present invention, a perchlorate ion, periodate ion, fluoroborate ion, hexafluorophosphate ion, arsenic hexafluoride ion, sulfate ion, boric acid ion, p-toluenesulfonate ion, methanesulfonate ion, trifluoromethanesulfonate ion, trifluoroacetate ion, thiocyanate ion, halogen ion, and the like can be given. Of these, a perchlorate ion, periodate ion, fluoroborate ion, hexafluorophosphate ion, and trifluoromethanesulfonate ion are preferable. A perchlorate ion is particularly preferable.

As examples of the salt used in the present invention, lithium perchlorate, lithium periodate, lithium fluoroborate, lithium hexafluorophosphate, sodium perchlorate, sodium periodate, sodium fluoroborate, sodium hexafluorophosphate, sodium trifluoromethanesulfonate, and tetraalkylammonium salt of perchloric acid, periodic acid, fluoroboric acid, tetrafluorophosphoric acid, or trifluoromethanesulfonic acid can be given. Of these, lithium perchlorate, sodium perchlorate, tetraalkylammonium salt of perchloric acid, and the like are preferable. These salts may be used either individually or in combination of two or more.

As the component (C) of the present invention, perchlorate is preferably used. The cation species may be any of the above cations insofar as the component (C) is perchlorate.

However, it is preferable that at least a part of the component (C) be a salt consisting of one cation selected from the group consisting of a lithium ion, sodium ion, and tetraalkylammonium ion and a perchlorate ion. It is also possible to use as component C a salt comprising ethoxy groups. When this type of salt is used, the presence of compound (D) is not required. The salt comprising ethoxy groups may comprise the same anions and cations as listed above. As an example of a salt comprising ethoxy groups an ethoxylated soya alkyl ammonium sulfate derivative commercially available under the name Larostat 264A, supplied by BASF Corp. can be given.

The amount (content) of the component (C) used in the present invention is preferably 0.01 to 20 wt %, and still more preferably 0.1 to 10 wt % of 100 wt % of the components (A), (B), (C), and (D) in total. If the amount (content) of the component (C) is less than 0.01 wt %, the surface resistivity of the laminate may be increased. If the amount (content) of the component (C) exceeds 20 wt %, the resulting cured film may exhibit insufficient hardness.

(D) Organic Polymer Including Structural Unit Derived from Alkylene Glycol

The organic polymer including the structural unit derived from an alkylene glycol optionally used in the radiation-curable resin composition of the present invention is suitably used to improve transparency of the resulting cured film.

The component (D) is not particularly limited insofar as the component (D) includes an alkylene glycol structure in the molecule irrespective of the main chain and the side chain of the polymer. This definition of (D) also includes compounds comprising more than one [symbol] O—CH₂—CH₂ [symbol] units in their molecular structure. For example, ethoxylated trimethylol propane, such as shown in formula 3, may be used. 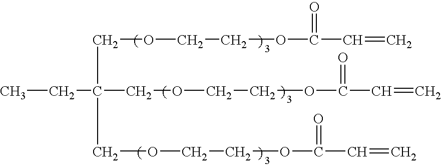
Such a product is commercially available under the name SR502, supplied by Sartomer. Another example of a suitable compound comprising more than one [symbol] O—CH₂—CH₂ [symbol] unit in its molecular structure is sulfonamide ethoxylated silicone polymer. This compound is present in commercially available mixture under the name Larostat HTS905, a proprietary mixture manufactured by BASF. At least a part of the component (D) is preferably a polymer including a polyalkylene glycol structure. As examples of such a polymer, polyethylene glycol, polypropylene glycol, copolymer of polyethylene glycol and polypropylene glycol, and the like can be given.

As the component (D) used in the present invention, a compound into which a (meth))acrylate structure is introduced by urethanization or esterification of the terminal hydroxyl group of the alkylene glycol structure is preferably used. Since the component (D) including the structure derived from (meth))acrylate undergoes radical polymerization with the component (B) to form a crosslinked structure, the hardness of the cured film may be increased.

The average molecular weight of the component (D) may vary between wide ranges. The average molecular weight of component (D) used in the present invention is preferably 300 to 10,000, and still more preferably 800 to 5,000. If the molecular weight of the component (D) is less than 300 or exceeds 10,000, the resulting cured film may exhibit insufficient hardness.

The amount (content) of the component (D), H (D) is used in the present invention is preferably 1 to 50 wt %, and still more preferably 5 to 30 wt % of 100 wt % of the components (A), (B), (C), and (D) in total. If the amount (content) of the component (D) is less than 1 wt %/, the resulting cured film may exhibit insufficient hardness. If the amount (content) of the component (C) exceeds 50 wt %, the resulting cured film may exhibit insufficient hardness.

The component (D) used in the present invention may be used as a conductive agent as a composite with the component (C). As commercially available products of such a conductive agent, PEL20A, PEL100, PEL500, PEL20BBL, PEL415, PEL-100UV (manufactured by Japan Carlit Co., Ltd.), and the like can be given. Of these, PEL20A, PEL00, and PEL-100UV are suitably used. These products are prepared by using perchlorate as the component (C). In a preferred embodiment, the radiation curable resin composition according to the invention comprises (A) silica particles including a polymerizable unsaturated group on the surface layer of the particles, (B) a radically polymerizable compound including two or more functional groups, (C) a salt of an inorganic and/or organic acid, and (D) an organic polymer including a structural unit derived from an alkylene glycol. These particular compositions produce, when suitable cured, a cured film which has excellent scratch resistance and adhesion, and is useful as a hard coat and, when used as the top layer in a laminate, results in a laminate which has low surface resistivity ad high transparency. The laminate is useful as an antistatic hard coat. It is an advantage of these particular compositions that they have a good long-term storage stability.

The radiation-curable resin composition including the components (A) to (C) and optionally (D) is cured by applying heat or radiation. In order to increase the curing speed, a heat-polymerization initiator or photoinitiator may be added as polymerization inition (E).

In the present invention, radiation refers to visible rays, ultraviolet rays, deep ultraviolet rays, X-rays, electron beams, α-rays, β-rays, γ-rays, and the like.

The amount of the polymerization initiator (E) is preferably 0.1 to 10 wt %, and still more preferably 0.5 to 7 wt % for 100 wt % of the components (A), (B), (C), and (D). The polymerization initiator (E) may be used either individually or in combination of two or more.

As examples of the photoinitiator, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, and the like can be given.

Of these, 1-hydroxycyclohexyl phenyl ketone, 2,2-dimethoxy-2-phenylacetophenone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide are preferable.

As commercially available products of the photoinitiator, Irgacure 184, 369, 651, 500, 907, CGI1700, CGI1750, CGI1850, CG24-61, Darocur 1116, 1173 (manufactured by Ciba Specialty Chemicals Co., Ltd.), Lucirin LR8728 (manufactured by BASF), Ubecryl P36 (manufactured by UCB), and the like can be given. Of these, Irgacure 184, 651, 907, Darocur 1173, and Lucirin LR8728 are preferable.

In the present invention, the photoinitiator and a heat-polymerization initiator may be used in combination.

As preferable examples of the heat polymerization initiator, peroxides, azo compounds, and like can be given. Specific examples include benzoyl peroxide, t-butyl-peroxybenzoate, azobisisobutyronitrile, and the like.

As the source of radiation used to cure the composition, any light source capable of curing the applied composition in a short period of time can be used.

As examples of the source of visible rays, sunlight, lamp, fluorescent lamp, laser, and the like can be given. As the source of ultraviolet rays, a mercury lamp, halide lamp, laser, and the like can be given. As examples of the source of electron beams, a method of utilizing thermoelectrons produced by a commercially available tungsten filament, a cold cathode method which causes electron beams to be generated by applying a high voltage pulse to a metal, a secondary electron method which utilizes secondary electrons produced by the collision of ionized gaseous molecules and a metal electrode, and the like can be given.

The composition of the present invention may further include additives such as a photosensitizer, polymerization inhibitor, polymerization adjuvant, leveling agent, wettability improver, surfactant, plasticizer, UV absorber, antioxidant, antistatic agent, inorganic filler, pigment, dye, and the like insofar as the effects of the present invention are not impaired.

The composition of the present invention may be prepared by mixing the above-described components with stirring. The preparation conditions (stirring temperature and stirring time, for example) are appropriately determined corresponding to the type of the component and the like.

There are no specific limitations to the application method of the composition of the present invention. A conventional method such as a roll coating method, spray coating method, flow coating method, dipping method, screen printing method, or ink jet printing method may be used.

The Laminate of the Present Invention is Described Below

The laminate includes a substrate layer and a layer of a cured film obtained by applying radiation to the radiation-curable resin composition including the components (A) to (D). The laminate preferably includes a first conductive layer between the substrate layer and a second layer of the cured film.

The first layer is a highly transparent film exhibiting conductivity. The first layer preferably includes conductive particles and/or a conductive organic compound. The conductive particles are metal oxide particles, and may be semiconductor inorganic particles. The surface resistivity of the first layer is preferably 1×10¹² ohm/square or less, and still more preferably 1×10⁹ ohm/square or less.

The conductive particles may be single metal oxides or metal oxides of an alloy of two or more metals. As the semiconductor, a single metal oxide in which the oxygen content differs to some extent from the stoichiometric composition, a solid solution or mixed crystal of oxides of two or more elements with an activation agent which forms an impurity level, or the like may be used.

The conductive particles may be powdered or dispersed in an organic solvent. It is preferable to prepare the composition using the conductive particles dispersed in an organic solvent, since uniform dispersibility can be easily obtained.

As examples the conductive particles, at least one type of particles selected from the group consisting of indium-doped tin oxide (ITO), antimony-doped tin oxide (ATO), fluorine-doped tin oxide (FTO), phosphorus-doped tin oxide (PTO), zinc antimonate, indium-doped zinc oxide, ruthenium oxide, rhenium oxide, silver oxide, nickel oxide, and copper oxide can be given. The first layer preferably includes antimony-doped tin oxide particles in an amount of 50 wt % or more.

As examples of commercially available products of such conductive particles, T-1 (ITO) (manufactured by Mitsubishi Materials Corporation), Passtran (ITO, ATO) (manufactured by Mitsui Mining & Smelting Co., Ltd.), SN-1 OOP (ATO) (manufactured by Ishihara Sangyo Kaisha, Ltd.), NanoTek ITO (manufactured by C.I. Kasei Co., Ltd.), ATO, FTO (manufactured by Nissan Chemical Industries, Ltd.), and the like can be given.

As commercially available products of the conductive particles dispersed in an organic solvent, SNS-10M (antimony-doped tin oxide dispersed in MEK), SNS-10B (antimony-doped tin oxide dispersed in butanol), FSS-10M (antimony-doped tin oxide dispersed in isopropyl alcohol) (manufactured by Ishihara Sangyo Kaisha, Ltd.), Celnax CX-Z401 M (zinc antimonate dispersed in methanol), Celnax CX-Z200IP (zinc antimonate dispersed in isopropyl alcohol) (manufactured by Nissan Chemical Industries, Ltd.), and the like can be given.

As a method for dispersing the powdered conductive particles in an organic solvent, a method which comprises adding a dispersing agent and an organic solvent to the conductive particles, adding beads of zirconia, glass, and alumina to the mixture as dispersion media, and dispersing the conductive particles by stirring the mixture at a high speed using a paint shaker, Henshel mixer, or the like can be given.

The amount of the dispersing agent to be added is preferably 0.1 to 5 wt % of the total weight of the composition. As examples of the dispersing agent, anionic, nonionic, or cationic surfactants such as polyacrylic acid alkaline metal salt, phosphate of polyether, polyethylene oxide/polypropylene oxide block-copolymer, nonyl phenyl polyether, and cetyl ammonium chloride can be given.

The amount of the organic solvent to be used is preferably 20 to 4,000 parts by weight, and still more preferably 100 to 1,000 parts by weight for 100 parts by weight of the conductive particles. If the amount is less than 20 parts by weight, the reaction may become nonuniform due to increased viscosity. If the amount exceeds 4,000 parts by weight, applicability may be Impaired.

As examples of the organic solvent, solvents having a boiling point of 200° C. or less at ordinary pressure can be given. Specific examples include alcohols, ketones, ethers, esters, hydrocarbons, and amides. These solvents can be used either individually or in combination of two or more. Of these, alcohols, ketones, ethers, and esters are preferable.

As examples of alcohols, methanol, ethanol, isopropyl alcohol, isobutanol, n-butanol, t-butanol, ethoxyethanol, butoxyethanol, diethylene glycol monoethyl ether, benzyl alcohol, phenethyl alcohol, and the like can be given. As examples of ketones, acetone, methyl ethyl ketone, methyl isobutyl ketone, cyclohexanone, and the like can be given.

As examples of ethers, dibutyl ether, propylene glycol monoethyl ether acetate, and the like can be given.

As examples of esters, ethyl acetate, butyl acetate, ethyl lactate, and the like can be given.

As examples of hydrocarbons, toluene, xylene, and the like can be given.

As examples of amides, formamide, dimethylacetamide, N-methylpyrrolidone, and the like can be given.

Of these, isopropyl alcohol, ethoxyethanol, butoxyethanol, diethylene glycol monoethyl ether, methyl ethyl ketone, methyl isobutyl ketone, cyclohexanone, propylene glycol monoethyl ether acetate, butyl acetate, and ethyl lactate are preferable.

As the conductive organic compound, conductive polymers such as polyaniline and polythiophene, charge transfer complexes such as 7,7,8,8-tetracyanoquinodimethane, and the like can be given. Of these, polyaniline is suitably used.

As commercially available products of the conductive organic compounds, PAS ink (solvent soluble polyaniline solution; manufactured by Japan Carlit Co., Ltd.), organic semiconductor COS (7,7,8,8-tetracyanoquinodimethane; manufactured by Japan Carlit Co., Ltd.), and the like can be given.

The first layer has transparency represented by a haze value of preferably 5% or less, and still more preferably 2% or less. If the haze value of the first layer is greater than 5%, the resulting laminate may exhibit inferior transparency.

The total light transmittance of the first layer is preferably 80% or more, and still preferably 85% or more. If the total light transmittance of the first layer is less than 80%, the resulting laminate may have poor appearance.

The second layer consists of a cured film obtained by curing the radiation-curable resin composition including the components (A) to (D) by applying radiation.

The thickness of the second layer is preferably 1 μm or more, and still more preferably 3 μm or more. If the thickness of the second layer is less than 1 μm, the resulting laminate may have insufficient hardness.

The second layer has transparency represented by a haze value of preferably 5% or less, and still more preferably 2% or less. If the haze value of the second layer is greater than 5%, the resulting laminate may exhibit inferior transparency.

The total light transmittance of the second layer is preferably 80% or more, and still preferably 85% or more. If the total light transmittance of the second layer is less than 80%, the resulting laminate may have poor appearance.

The surface resistivity of the second layer is 1×10¹² ohm/square or less, preferably 1×10¹⁰ ohm/square or less, and still more preferably 1×10⁸ ohm/square or less.

The thickness of the second layer is preferably 2 to 10 μm when applied to a touch panel, CRT, or the like, in which scratch resistance on the outermost surface is important.

When the thickness of the second layer is 3 μm or more, the haze value of the second layer is preferably 1% or less.

There are no specific limitations to the material for the substrate used for the laminate of the present invention. Glass, plastic, or the like is preferably used in the form of a film or fiber. A plastic film is particularly preferably used as the substrate. As examples of such a plastic, polyethyleneterephthalate, polycarbonate, polymethacrylate, polystyrene/polymethacrylate copolymer, polystyrene, polyester, polyolefin, triacetylcellulose, diallylcarbonate of diethylene glycol (CR-39), ABS, Nylon (trade name), epoxy resin, melamine resin, cyclized polyolefin resin, and the like can be given.

In the laminate of the present invention, another layer (high-refractive-index layer or low-refractive-index layer, for example) may be further provided on the second layer. Another layer (medium-refractive-index layer or high-refractive-index layer, for example) may be provided between the substrate layer and the first layer or between the first layer and the second layer. The laminate may be formed by using a conventional method.

### EXAMPLE

The present invention is described below in more detail by examples. However, the following examples should not be construed as limiting the present invention. In the following description, “part” and “%” respectively represent “part by weight” and “wt %” unless otherwise indicated.

### Preparation Example 1 Synthesis of Organic Compound (Ab)

20.6 parts of isophorone diisocyanate was added dropwise to a solution of 7.8 parts of 3-mercaptopropyltrimethoxysilane and 0.2 part of dibutyltin dilaurate in dry air at 50° C. in one hour. The mixture was stirred at 60° C. for three hours. After the addition of 71.4 parts of pentaerythritol triacrylate dropwise at 30° C. in one hour, the mixture was stirred at 60° C. for three hours. The residual isocyanate content in the resulting product was analyzed and found to be 0.1% or less, indicating that the reaction was completed almost quantitatively. The resulting compound had a thiourethane bond, urethane bond, alkoxysilyl group, and polymerizable unsaturated group in the molecule (organic compound (Ab-1)).

### Preparation Example 2 Preparation of Reactive Silica Particles (A)

A mixture of 8.7 parts of the organic compound (Ab-1) synthesized in Preparation Example 1, 91.3 parts of methyl ethyl ketone silica sol (“MEK-ST” manufactured by Nissan Chemical Industries, Ltd., number average particle diameter: 0.022 μm, silica concentration: 30%), and 0.1 part of ion-exchanged water was stirred at 60° C. for three hours. After the addition of 1.4 parts of methyl orthoformate, the mixture was stirred at 60° C. for one hour under heating to obtain a dispersion liquid of the reactive particles (A) (dispersion liquid (A-1)). 2 g of the dispersion liquid (A-1) was weighed on an aluminum dish and dried on a hot plate at 175° C. for one hour. The dried product was weighed to confirm that the solid content was 35%.

### Preparation Example 2-a Preparation of Reactive Silica Particles (A-2)

A mixture of 7.8 parts of the organic compound (Ab-1) synthesized in Preparation Example 1, 82.5 parts of methanol silica sol (“MT-ST” manufactured by Nissan Chemical Industries, Ltd., number average particle diameter: 0.022 μm, silica concentration: 30%), and 0.15 part of p-Methoxyphenol was stirred at 60° C. for three hours. 1.24 parts of methyltrimethoxy silane was then added and the reaction mixture was stirred at 60° C. for one hour. After the addition of 8.3 parts of methyl orthoformate, the mixture was stirred at 60° C. for one hour under heating to obtain a dispersion liquid of the reactive particles (A-2) (dispersion liquid (A-2)).

### Preparation Example 2-b Preparation of Reactive Zinc Antimonate Particles (A-3)

A mixture of 5.59 parts of the organic compound (Ab-1) synthesized in Preparation Example 1, 93.0 parts of isopropanol zinc antimonite nanoparticle sol(“Celnax Z210IP” manufactured by Nissan Chemical Industries, Ltd., number average particle diameter: 0.020 μm, zinc antimonate concentration: 20%), 0.01 parts p-methoxy phenol, and 0.1 part of ion-exchanged water was stirred at 60° C. for three hours. After the addition of 1.3 parts of methyl orthoformate, the mixture was stirred at 60° C. for one hour under heating to obtain a dispersion liquid of the reactive particles (A) (dispersion liquid (A-3)).

### Preparation Example 2-c Preparation of Reactive Zirconium Oxide Particles (A-4)

A mixture of 2.1 parts of the organic compound (Ab-1) synthesized in Preparation Example 1, 97.9 parts of Zirconia particles (methyl ethyl ketone Zirconia sol, number average particle diameter: 0.01 μm, Zirconia concentration: 30%), 0.01 parts p-methoxy phenol, and 0.1 part of ion-exchanged water was stirred at 60° C. for three hours. After the addition of 1.0 parts of methyl orthoformate, the mixture was stirred at 60° C. for one hour under heating to obtain a dispersion liquid of the reactive particles (A) (dispersion liquid (A-4)).

### Preparation Example 3

A mixed solution of 94.4 parts of methyl ethyl ketone ATO sol (“SNS-10M” manufactured by Ishihara Sangyo Kaisha, Ltd.), 4.0 parts of dipentaerythritol hexacrylate, 1.0 part of 2-methyl-1-(4-(methylthio)phenyl)-2-morpholinopropanon-1, and 0.01 part of p-methoxyphenol was stirred at 25° C. for three hours to obtain a composition 1. The solid content of the composition 1 determined under the same conditions as in Preparation Example 2 was 34%.

### Preparation Example 4

A mixed solution of 20 parts of an N-methyl-2-pyrrolidone solution of polyaniline (“PAS ink A liquid” manufactured by Japan Carlit Co., Ltd.), 20 parts of a dopant for polyaniline (“PAS ink B liquid” manufactured by Japan Carlit Co., Ltd.), and 1 part of a curing agent for polyaniline (“PAS ink C liquid” manufactured by Japan Carlit Co., Ltd.) was stirred at 25° C. for 30 minutes to obtain a composition 2.

### Comparative Example 1

A mixed solution of 73.5 parts of the dispersion liquid (A-1) obtained in Preparation Example 2, 24.1 parts of dipentaerythritol hexacrylate, 1.5 parts of 1-hydroxycyclohexyl phenyl ketone, 10.9 parts of 2-methyl-1-(4-(methylthio)phenyl)-2-morpholinopropanon-1, and 0.01 part of p-methoxyphenol was stirred at 25° C. for three hours to obtain a composition 3. The solid content of the composition 2 determined under the same conditions as in Preparation Example 2 was 51%.

### Example 1

A mixed solution of 3100 parts of the composition obtained in Comparative Example 1, 10 parts of a conductive agent in which lithium perchlorate and a polyethylene glycol-polypropylene glycol copolymer with an average molecular weight of 1300 were complexed at a ratio of 10:90 (“PEL20A” manufactured by Japan Carlit Co., Ltd.), and 10 parts of methyl ethyl ketone was stirred at 25° C. for three hours to obtain a composition 4. The solid content of the composition 4 determined under the same conditions as in Preparation Example 2 was 51%.

### Example 2

A mixed solution of 3100 parts of the composition obtained in Comparative Example 1, 20 parts of a conductive agent in which lithium perchlorate and a polyethylene glycol-polypropylene glycol copolymer with an average molecular weight of 1300 were complexed at a ratio of 10:90 (“PEL20A” manufactured by Japan Carlit Co., Ltd.), and 20 parts of methyl ethyl ketone was stirred at 25° C. for three hours to obtain a composition 5. The solid content of the composition 5 determined under the same conditions as in Preparation Example 2 was 51%.

### Example 3

A composition 6 was obtained in the same manner as in Example 2 except for using a conductive agent in which lithium perchlorate and a polyethylene glycol-polypropylene glycol copolymer modified with urethane acrylate at a terminal were complexed at a ratio of 10:90 (“PEL100UV” manufactured by Japan Carlit Co., Ltd.) instead of the conductive agent in which lithium perchlorate and a polyethylene glycol-polypropylene glycol copolymer with an average molecular weight of 1300 were complexed at a ratio of 10:90 (“PEL20A” manufactured by Japan Carlit Co., Ltd.). The solid content of the composition 6 determined under the same conditions as in Preparation Example 2 was 52%.

Table 1 shows the content of each component of the compositions prepared in Preparation Examples 3 and 4. Table 2 shows the content of each component of the compositions prepared in Comparative Example 1 and Examples 1 to 3.

TABLE 1

| | |
|---|---|
| Preparation | Preparation |
| Example 3 | Example 4 |

Composition

| | 1 | 2 |
|---|---|---|
| MEK dispersion liquid | 94.4 | |
| of ATO | | |
| B-1 | 4.0 | |
| E-2 | 1.0 | |
| p-Methoxyphenol | 0.01 | |
| PAS ink A liquid | | 20 |
| PAS ink B liquid | | 20 |
| PAS ink C liquid | | 1 |
| Methanol dispersion of | | |
| Nanosilica particles | | |
| Total | 99.41 | 41 |
| Solid content (%) | 34 | 0 |

TABLE 2

| | | | | Comparative |
|---|---|---|---|---|
| | Example 1 | Example 2 | Example 3 | Example 1 |
| | Composition | | | |
| | 4 | 5 | 6 | 3 |
| Reactive silica | | | | |
| particles (A) | | | | |
| A-1 | 44.8 | 41.1 | 41.1 | 49.3 |
| Radically polymerizable | | | | |
| compound (B) | | | | |
| B-1 | 41.9 | 38.4 | 38.4 | 46.1 |
| Perchlorate (C) | | | | |
| C-1 | 0.9 | 1.7 | 1.7 | |
| Organic polymer | | | | |
| D-1 | 8.2 | 15.0 | | |
| D-2 | | | 15.0 | |
| Radical initiator (E) | | | | |
| E-1 | 2.6 | 2.4 | 2.4 | 2.9 |
| E-2 | 1.6 | 1.4 | 1.4 | 1.7 |
| Organic solvent | | | | |
| MEK | 100 | 100 | 100 | 100 |
| Total | 200 | 200 | 200 | 200 |
| Solid content (%) | 51 | 51 | 52 | 51 |

| | Composition | | | | |
|---|---|---|---|---|---|
| | 7 | 8 | 9 | 10 | 11 |
| Reactive particles (A) | | | | | |
| A-1 | 25.0 | | | | |
| A-2 | | 24.1 | 24.5 | | |
| A-3 | | | | 2.5 | 2.5 |
| A-4 | | | | 14.8 | 14.8 |
| Radically polymerizable | | | | | |
| compound (B) | | | | | |
| B-1 | 22.6 | 12.9 | 22.1 | 20.6 | 20.6 |
| Salt (C) | | | | | |
| C-2 | 5.0 | 5.0 | | | |
| C-3 | | | 2.0 | | |
| C-4 | | | | 2.5 | |
| C-5 | | | | | 2.5 |
| Organic polymer | | | | | |
| D-3 | | | 8.6 | | |
| D-4 | | | | 2.0 | 2.0 |
| Radical initiator (E) | | | | | |
| E-1 | 0.6 | 0.9 | 0.6 | 0.6 | 0.6 |
| E-2 | 0.6 | 0.6 | 0.6 | 0.3 | 0.3 |
| Additive (F) | | | | | |
| F-1 | | 0.5 | | 0.1 | 0.1 |
| F-2 | | | 4.9 | | |
| Organic solvent | | | | | |
| MEK | 46.3 | | | 49.2 | 49.2 |
| Methanol | | 47.5 | 45.4 | 7.5 | 7.5 |
| Total | 100.0 | 100.0 | 100.0 | 100.0 | 100.0 |
| Surface resistivity | 1 × 10¹² | 9 × 10¹¹ | 2 × 10¹¹ | 1 × 10⁹ | 1 × 10⁸ |
| cured film (Ω/sq.) | | | | | |
| % Haze cured film | 0.73 | 0.77 | <1.0 | 4.4 | 4.3 |

The components shown in Tables 1 and 2 are as follows.
A-1: Reactive silica particles (A) prepared in Preparation Example 2
A-2: Reactive silica particles (A) prepared in Preparation Example 2-a
A-3: Reactive silica particles (A) prepared in Preparation Example 2-b
A-4: Reactive silica particles (A) prepared in Preparation Example 2-c
B-1: Dipentaerythritol hexaacrylate, SR 399 available from Sartomer Company Inc.
C-1: Lithium perchlorate
C-2: Larostat 264A, Ethoxylated soya alkyl ammonium sulfate derivative available from BASF Corp.
C-3: Lithium trifluoromethanesulfonate available from Aldrich Chemical
C-4: Lithium acetyl acetonate available from Aldrich Chemical
C-5: Lithium dodecyl sulfate available from Aldrich Chemical
D-1: Polyethylene glycol-polypropylene glycol copolymer
D-2: Polyethylene glycol-polypropylene glycol copolymer modified with urethane acrylate at terminal
D-3: SR 502, Ethoxylated trimethylolpropane triacrylate available from Sartomer Company, Inc.
D-4: Larostat HTS905, sulfonamide ethoxylate silicone copolymer, proprietary mixture manufactured by BASF Corp.
E-1: 1-Hydroxycyclohexyl phenyl ketone, Irgacure 184 available from Ciba Specialty Chemicals
E-2: 2-Methyl-1-[4-(methylthio)phenyl]-2-morpholinopropanone-1, Irgacure 907 available from Ciba Specialty Chemicals
F-1: Irganox 3114, 1,3,5-Tris(3,5-di-(tert)-butyl-4-hydroxybenzyl)-1,3,5-triazine-2,4,6(1H,3H,5H)-trione available from Ciba Specialty Chemicals
F-2: Hybrane SL1950, hyperbranched polyesteramide available from DSM Fine Chemicals
MEK: Methyl ethyl ketone available from Exxon Chemicals

### Example 4

The composition 1 obtained in Preparation Example 3 was applied to polyethyleneterephthalate with a thickness of 188 μg/m (“#A4300” manufactured by Toyobo Co., Ltd.) using a bar coater so that the thickness after drying was 0.5 μm. The applied composition was dried at 80° C. in a hot-blast oven for three minutes, and irradiated using a conveyer-type mercury lamp at a dose of 1 J/cm² to form a first layer.

The composition 4 obtained in Example 1 was applied to the first layer to a thickness of 5 μm using a bar coater. The applied composition was allowed to stand at 80° C. for one minute in a hot-blast oven. The composition was then irradiated with ultraviolet rays at a dose of 1 J/cm² in air using a conveyer-type mercury lamp (manufactured by ORC Co., Ltd.) to form a second layer.

The resulting product was allowed to stand at a temperature of 23° C. and a relative humidity of 50% for 24 hours to obtain a laminate specimen.

### Examples 5 to 7 and Comparative Example 2

A laminate specimen was obtained in the same manner as in Example 4 except for using the compositions shown in Table 3 instead of the compositions 1 and 4 used in Example 4.

### Example 8

The composition 4 obtained in Example 1 was applied to polyethyleneterephthalate with a thickness of 188 g/m (“#A4300” manufactured by Toyobo Co., Ltd.) using a bar coater so that the thickness after drying was 5 μm. The applied composition was dried at 80° C. in a hot-blast oven for three minutes, and irradiated using a conveyer-type mercury lamp at a dose of 1 J/cm² to form only a second layer.

The resulting product was allowed to stand at a temperature of 23° C. and a relative humidity of 50% for 24 hours to obtain a specimen.

The compositions obtained in Examples 7-11 were applied to a polyester film (or Dupont-Teijin Melinex® #453, thickness: 177.8 microns) using a wire bar coater (examples 7-9: #10 wire bar coater resulting in wet coating thickness of 25.4 microns and dried film thickness of 13 microns; examples 10-11: #3 wire bar coater resulting in wet coating thickness of 7.4 microns and dried film thickness of 3 microns), and dried in an oven at 80° C. for three minutes to form films. The films were cured by applying ultraviolet rays in air at a dose of 1 J/cm² using a metal halide lamp to obtain cured films.

Evaluation of Laminate

In order to demonstrate the effect of the present invention, the above laminate in Compositions 1-6 and Comparative Example 1 (Composition 3) and the coating compositions in Compositions 7-11 were evaluated. The evaluation methods are described below. The evaluation results for laminates of Compositions 1-6 are shown in Table 3.

Transparency

The haze value (%) of the specimen was measured by using a color haze meter (manufactured by Suga Seisakusho, Co., Ltd.) or Haze-gard plus model (manufactured by BYK-Gardner Corp.). According to ASTM D1003. The haze value was evaluated after subtracting the haze value of the substrate film (0.7%).

Antistaticity

The surface resistivity (ohm/square) of the specimen was measured by using a high resistance meter (“HP4339A” manufactured by Hewlett Packard) at an electrode area with an diameter of 26 mm and an applied voltage of 100 V or Keithley model 65017A electrometer with model 8009 resistivity test fixture and an applied voltage of 100 V.

Pencil Hardness

The pencil hardness of the specimen was measured according to JIS K5400 at a load of 1 kg using a pencil scratch tester.

TABLE 3

| | | | | | | | | Comparative |
|---|---|---|---|---|---|---|---|---|
| | | | Example | | | | | Example |
| | | | 4 | 5 | 6 | 7 | 8 | 2 |
| Laminate | First layer | Composition | 1 | 1 | 1 | 2 | None | 1 |
| | Second layer | Composition | 4 | 5 | 6 | 4 | 4 | 3 |
| | Evaluation | Transparency (%) | 0.7 | 0.7 | 0.6 | 0.9 | 0.7 | 0.8 |
| | | Antistaticity | 3 × 10¹⁰ | 1 × 10⁹ | 4 × 10¹⁰ | 2 × 10⁹ | 3 × 10¹³ | 3 × 10¹⁵ |
| | | (ohm/square) | | | | | | |
| | | Pencil hardness | 2H | H | 2H | 2H | 2H | 2H |

### INDUSTRIAL APPLICABILITY

The cured film of the radiation-curable resin composition of the present invention exhibits excellent scratch resistance and adhesion and is useful as a hard coat.

Since the laminate of the present invention has an excellent antistatic function, the laminate is useful as an antistatic film when disposed on substrates in various shapes such as a film shape, sheet shape, or lens shape.

As application examples of the cured film or the laminate of the present invention, use as a hard coat provided to prevent scratches on the surface of the product or adhesion of dust due to static electricity, such as a protective film for touch panels, transfer foil, hard coat for optical disks, film for automotive windows, antistatic protective film for lenses, and surface protective film for a well-designed cosmetic container, use as an antistatic antireflection film for various display panels such as a CRT, liquid crystal display panel, plasma display panel, and electroluminescent display panel, use as an antistatic antireflection film for plastic lenses, polarization film, and solar battery panel, and the like can be given.

1. A radiation curable resin composition comprising (A) reactive oxide particles, prepared by reacting particles of at least one oxide of an element selected from the group consisting of silicon, aluminum, zirconium, titanium, zinc, germanium, indium, tin, antimony and cerium, with an organic compound that includes a polymerizable unsaturated group, (B) a radically polymerizable compound including two or more functional groups, (C) a salt of an inorganic acid and/or an organic acid, and optionally (D) an organic polymer including a structural unit derived from an alkylene glycol.

2. A radiation-curable resin composition according to claim 1, wherein the reactive oxide particles have been prepared from silica particles.

3. The radiation-curable resin composition according to claim 1, wherein at least a part of the salt (C) of an inorganic acid and/or an organic acid is a salt formed of one cation selected from the group consisting of a lithium ion, sodium ion, and tetraalkylammonium ion and a perchlorate ion.

4. The radiation-curable resin composition according to claim 1, comprising component D and wherein at least a part of the organic polymer (D) including a structural unit derived from an alkylene glycol is at least one polymer selected from the group consisting of polyethylene glycol, polypropylene glycol, and a copolymer of polyethylene glycol and polypropylene glycol.

5. The radiation-curable resin composition according to claim 1, wherein the organic polymer (D) including a structural unit derived from an alkylene glycol includes a structure derived from (meth))acrylate.

6. A radiation-curable resin composition according to claim 1, comprising methanol, ethanol, isopropanol or butanol.

7. A cured film obtained by curing the radiation-curable resin composition according to claim 1 by applying radiation.

8. A laminate comprising a substrate layer and a layer of the cured film according to claim 7.

9. The laminate according to claim 8, comprising a first layer exhibiting conductivity between the substrate layer and a second layer formed of the cured film.

10. The laminate according to claim 9, wherein the second layer has surface resistivity of 1×10¹² ohm/square or less.

11. The laminate according to claim 9, wherein the first layer includes 50 wt % or more of antimony-doped tin oxide particles.

12. The laminate according to claim 9, wherein the first layer includes polyaniline.
